(19) United States
(12) Patent Application Publication
(10) Pub. No.: US 2026/0047722 A1
(43) Pub. Date: Feb. 19, 2026

(54) SYSTEM AND METHOD FOR DISPENSING GROUND COFFEE

(71) Applicant: Breville Pty Limited, Alexandria NSW (AU)

(72) Inventors: Lochana Subasekara WIDANAGAMAGE DON, Alexandria NSW (AU); Con PSAROLOGOS, Alexandria NSW (AU); Jack Duncan GILMORE, Alexandria NSW (AU)

(21) Appl. No.: 19/101,996

(22) PCT Filed: Aug. 2, 2023
(86) PCT No.: PCT/AU2023/050721

§ 371 Date: Feb. 7, 2025

(30) Foreign Application Priority Data
Aug. 8, 2022 (AU) 2022902217

(51) Int. Cl. A47J 42/40

(52) U.S. Cl. CPC A47J 42/40

(57) ABSTRACT

A dispensing system configured to dispense ground coffee and located adjacent a coffee grinder, the dispensing system comprising an outlet connected to a chamber containing the ground coffee, the outlet having an opening through which the ground coffee is dispensed, at least one electrode located in the outlet, and a booster circuit configured to generate an output voltage higher than an input voltage, the booster circuit being connected to the at least one electrode, wherein the output voltage is used to generate an electric charge on the at least one electrode.

### FIELD

The present invention relates to a system and method for dispensing ground coffee. In particular, the invention relates to a dispensing system configured to dispense ground coffee, and use thereof, the dispensing system being located adjacent a coffee grinder.

### BACKGROUND

Coffee bean grinding machines typically include a hopper in which coffee beans are placed to grind the coffee beans and deliver ground coffee to a receptacle. Coffee bean grinding machines can also be incorporated into coffee brewing machines. During the grinding process, due to the friction with the grinder, electrostatic charges will be generated, which are picked up by the ground coffee particles. These ground coffee particles with electrostatic charges tend to scatter as they are dispensed, resulting in ground coffee particles accumulating on surfaces of the grinding machine and on the adjacent bench surface. In addition to the mess created due to this scattering effect, a portion of the ground coffee is deemed unusable as it is not received in the receptacle and the reduced quantity of ground coffee in the receptacle would form an improper dosage for brewing a coffee.

### SUMMARY

It is an object of the present invention to substantially overcome, or at least ameliorate, one or more of the disadvantages of existing arrangements, or at least provide a useful alternative to existing arrangements.

In a first aspect, although not necessarily the only or broadest form, the invention resides in a dispensing system configured to dispense ground coffee and located adjacent a coffee grinder, the dispensing system comprising:
an outlet connected to a chamber containing the ground coffee, the outlet having an opening through which the ground coffee is dispensed;
at least one electrode located in the outlet;
a booster circuit configured to generate an output voltage higher than an input voltage, the booster circuit being connected to the at least one electrode,
wherein the output voltage is used to generate an electric charge on the at least one electrode.

Preferably, the at least one electrode comprises a first electrode and a second electrode. Preferably, the first and second electrodes are located across a flow pathway of the ground coffee through the outlet. Preferably, the second electrode is spaced from the first electrode. Preferably, the second electrode is located across the first electrode.

Preferably, the coffee grinder comprises a hopper, an inlet and the chamber. Preferably, the chamber is connected to the inlet. Preferably, the hopper receives coffee beans. Preferably, the coffee beans move into the chamber from the hopper via the inlet. Preferably, the chamber comprises a grinding member to grind the coffee beans.

Preferably, the first and second electrodes are located adjacent the opening. Preferably, the first and second electrodes are located adjacent a proximal end of the outlet. Preferably, the first and second electrodes are located adjacent the chamber.

Preferably, the booster circuit is a high voltage booster circuit or a bipolar high voltage step up circuit. Preferably, the input voltage is in the range of about 5-10 V. Preferably, the output voltage is in the range of about ±1000-1500 V. Preferably, the output voltage is about ±1500 V.

Preferably, the output voltage is adjustable. Preferably, the output voltage can be adjusted by a user. Preferably, the output voltage generates a positive electric charge on the first electrode. Preferably, the output voltage generates a negative electric charge on the second electrode. Preferably, the first and second electrodes have a triangular cross-sectional shape. Preferably, the first and second electrodes are formed of plates.

Preferably, the electric charge generated on the at least one electrode is adjustable. Preferably, the electric charge generated on the first electrode is independently adjustable. Preferably, the electric charge generated on the second electrode is independently adjustable. Preferably, the space between the first and second electrodes is adjustable.

Preferably, the ground coffee comprises a plurality of electrically charged particles. Preferably, electrostatic charges on the electrically charged particles are measured by a sensor. Preferably, the ground coffee comprises positively charged particles. Preferably, the ground coffee comprises negatively charged particles. Preferably, the electrostatic charges on the electrically charged particles are discharged by the at least one electrode as the ground coffee flows past the at least one electrode. Preferably, electrostatic charges on the negatively charged particles are discharged by the first electrode. Preferably, electrostatic charges on the positively charged particles are discharged by the second electrode.

In a second aspect, the invention resides in a method of dispensing ground coffee from an opening located adjacent a coffee grinder, the method comprising:
causing the ground coffee contained in a chamber to flow through an outlet, the opening being located at a distal end of the outlet;
generating, by a booster circuit, an output voltage higher than an input voltage, the booster circuit being connected to at least one electrode located in the outlet;
generating, with the output voltage, an electric charge on the at least one electrode; and
dispensing the ground coffee from the opening subsequent to the ground coffee having flowed past the at least one electrode.

Preferably, generating the output voltage by the booster circuit includes adjusting the output voltage. Preferably, generating the electric charge on the at least one electrode includes adjusting the electric charge generated on the at least one electrode.

Preferably, the ground coffee flows through the space between the first and second electrodes. Preferably, the electrostatic charges on the electrically charged particles are discharged by the at least one electrode as the ground coffee flows past the at least one electrode.

### BRIEF DESCRIPTION OF THE DRAWINGS

For a more complete understanding of the present invention, exemplary embodiments of the invention are explained in more detail in the following description with reference to the accompanying drawing figures, in which like reference signs designate like parts and in which:

FIG. 1a is a front view of a dispensing system, according to an embodiment of the invention, installed in a coffee grinding machine.

FIG. 1b is a cross-sectional view of the coffee grinding machine of FIG. 1a taken along line “A-A”.

FIG. 1c is a detail view of the outlet and opening of the dispensing system of FIG. 1a.

FIG. 2 is a schematic system diagram of a portion of the dispensing system of FIG. 1a.

### DETAILED DESCRIPTION

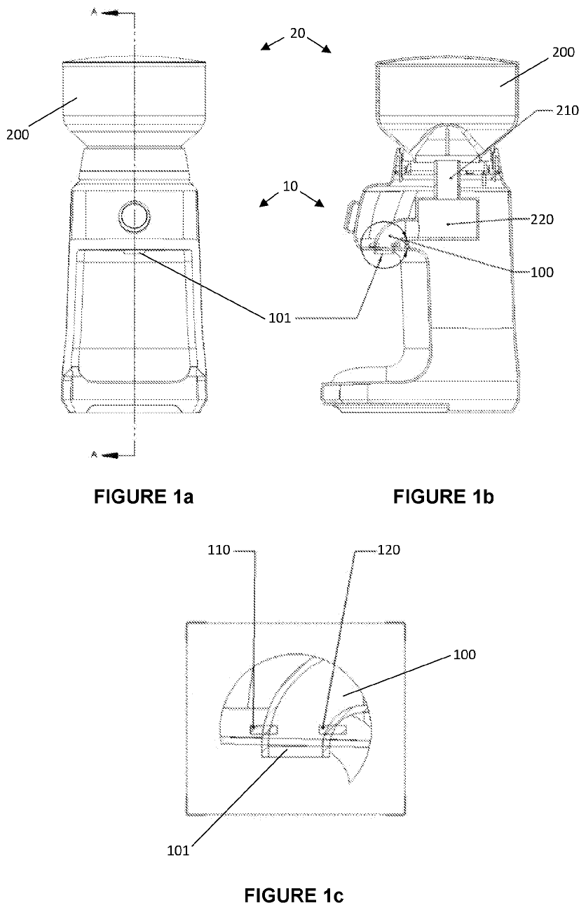

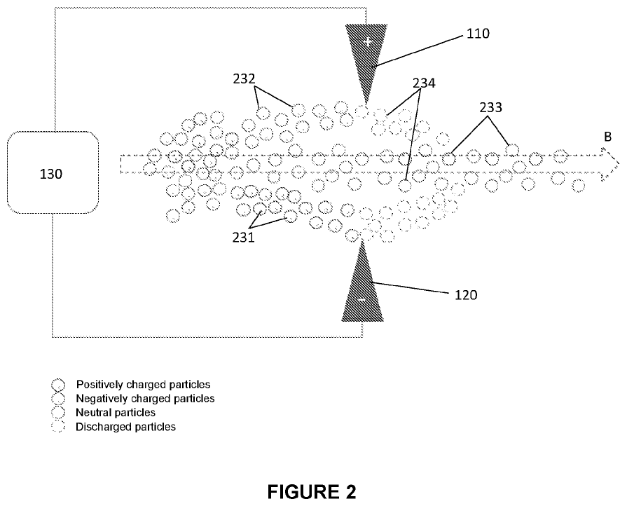

FIGS. 1-2 illustrate a dispensing system 10 configured to dispense ground coffee. As seen in FIGS. 1a and 1b, in this embodiment, the dispensing system 10 is installed/located in a coffee grinding machine 20. However, in further embodiments, the dispensing system 10 may be located in other type of machines that include a coffee grinder assembly, for example, coffee machine, espresso machines, drip filter or pour over coffee machines etc.

The coffee grinding machine 20 comprises a hopper 200, an inlet 210 and a chamber 220 connected to the inlet 210. The hopper 200 receives coffee beans that, when the coffee grinding machine 20 is being used, move downwards into the chamber 220 via the inlet 210. The chamber 220 comprises grinding members (not shown) to grind the coffee beans into ground coffee.

The dispensing system 10 comprises an outlet 100 connected to the chamber 220, a first electrode 110 and a second electrode 120 located in the outlet 100, and a booster circuit 130 connected to the first and second electrodes 110, 120. The outlet 100 has an opening 101 through which the ground coffee is dispensed and the first and second electrodes 110, 120 are located adjacent the opening 101. However, in further embodiments, only one electrode (positive or negative) may be located in the outlet 100 and/or the electrode(s) may be located at any point along the outlet 100, for example, adjacent the proximal end of the outlet 100 that is opposite to the distal end with the opening 101 and is connected to the chamber 220. Locating the first and second electrodes 110, 120 adjacent the proximal end of the outlet 100 that is connected to the chamber 220 can be advantageous as the first and second electrodes 110, 120 are likely to be inaccessible by a user, thereby improving user safety, and the amount of ground coffee particles sticking to the inner wall of the outlet 100 would be minimized as the particles would be discharged soon after they enter the outlet 100.

Throughout the specification the term “electrical connection”, “connected” or “electrically connected” does not necessarily define a direct connection, but can also refer to an indirect connection, e.g. with a further electrical component, such as a resistor, located between the two points being connected, or it may also refer to being communicatively coupled.

The booster circuit 130, in the form of a high voltage booster circuit or a bipolar high voltage step up circuit, is configured to generate an output voltage higher than an input/supply voltage received by the booster circuit 130. The booster circuit 130 boosts the low input/supply voltage (for example, 5 V or 10 V) to a high output voltage (for example, ±1000-1500 V), while generating very low current. Preferably, the output voltage is ±1500 V which is the optimum voltage to achieve minimum scattering of the ground coffee, although the output voltage may be higher than ±1500 V.

The output voltage generated by the booster circuit 130 can also be varied/adjusted by a user, via a user interface, to a preferred value in order to achieve a desired scattering effect or to account for variations in the amount of electrostatic charges generated on the ground coffee particles across different types of coffee beans. The user may, in response to an observed scattering of the ground coffee, choose to adjust the output voltage to a preferred value that produces a desired amount of scattering of the ground coffee. For example, if some scattering is being observed despite the output voltage being used to generate an electric charge on the first and second electrodes 110, 120, the user can increase the output voltage to further reduce the scattering of ground coffee. However, in further embodiments, the output voltage may be adjusted remotely by a user device or automatically by the coffee grinding machine 20 based on the amount of scattering detected by sensors.

The output voltage is used to generate a positive electric charge on the first electrode 110 and a negative electric charge on the second electrode 120, with the first and second electrodes 110, 120 being spaced from each other and located across from each other. In this embodiment, the first and second electrodes 110, 120 have a triangular cross-sectional shape with a pointed edge, as seen in FIG. 2. However, in further embodiments, the first and second electrodes 110, 120 may be in the form of a planar or curved plate of any shape and/or the first electrode 110 may be differently shaped and/or sized relative to the second electrode 120.

The electric charge generated on the first electrode 110 or the second electrode 120 can be independently adjusted by the user, i.e. the user can selectively adjust the electric charge generated on either electrode independently so that more positive or negative ions are generated at the respective electrode, instead of a balanced amount of positive and negative ions. It may be necessary to do so if the grinding of the coffee beans results in the generation of higher positive or negative electrostatic charges on the ground coffee particles, instead of a balanced amount of positive and negative electrostatic charges. In further embodiments, the distance/space between the first and second electrodes 110, 120 may also be adjusted by a user.

The first and second electrodes 110, 120 are located across a flow pathway “B” of the ground coffee through the outlet 100 such that the ground coffee flows through the space between the first and second electrodes 110, 120 as it moves through the outlet 100 and is dispensed from the opening 101. As the ground coffee particles move through the positive and negative electric fields generated by the first and second electrodes 110, the electrostatic charges formed on the particles are discharged and the discharged particles are not scattered as they exit the opening 101. The electrostatic charges formed on the particles can be measured by a sensor (for example, an optical sensor, camera etc.) prior to the particles moving through the space between the first and second electrodes 110, 120, as well as after the particles have moved past the first and second electrodes 110, 120 and are exiting the opening 101. The measurement of any remaining electrostatic charges on the particles exiting the opening 101 can be recorded by a controller (not shown) and aids in minimizing the scattering effect by automatically adjusting the output voltage of the booster circuit 130 for subsequent use or providing a recommendation to the user to adjust the voltage output or the electric charge generated on either of the electrodes.

In use, the hopper 200 is filled with coffee beans that are to be ground. The coffee beans then travel to the chamber 220 from the hopper 200 via the inlet 210. In the chamber 220, the coffee beans are ground into ground coffee by grinding members. During the grinding process, due to the friction with the grinding members, electrostatic charges will be formed on the ground coffee particles, resulting in a mix of positively charged particles 231, negatively charged particles 232 and neutral particles 233, as shown in FIG. 2.

The ground coffee contained in the chamber 220 is dispensed via the opening 101 of the outlet 100, with the ground coffee particles flowing through the outlet 100 along the flow pathway “B”. In particular, the ground coffee particles flow through the space between the first and second electrodes 110, 120 and the electrostatic charges formed on the ground coffee particles are discharged by the electric field formed around the first and second electrodes 110, 120 such that the positively charged particles 231 and the negatively charged particles 232 are transformed into discharged particles 234 that have no electrostatic charges associated with them (similar to the neutral particles 233). The neutral particles 233 remain unaffected by the electric field formed around the first and second electrodes 110, 120. As the discharged particles 234 and the neutral particles 233 flow past the first and second electrodes 110, 120 and through the opening, they do not scatter as there are no electrostatic charges formed on the discharged particles 234 or the neutral particles 233, and the particles follow a substantially linear flow pathway.

In some embodiments, the dispensing system 10 is installed in a coffee grinding machine that includes a movable grinding member and an immovable grinding member, with the immovable grinding member having an electric charge generated thereon. The electric charge generated on the immovable grinding member may be positive or negative, while the movable grinding member would remain neutral and have no electric charges generated thereon. The coffee grinding machine with the electrically charged immovable grinding member may also be used with other known dispensing systems.

In further embodiments, the dispensing system 10 is installed in a coffee grinding machine that includes a movable grinding member and an immovable grinding member, with both grinding members having an electric charge generated thereon. The coffee grinding machine includes one or more insulating members to ensure that the electric charge does not leak into the motor that drives the grinding members. The one or more insulating members include plastic gears that are used to connect the motor to the grinding members. The coffee grinding machine with the electrically charged movable and immovable grinding members may also be used with other known dispensing systems.

Moreover, in further embodiments, the dispensing system 10 is installed in a coffee grinding machine that includes at least two electrodes in the hopper. The electrodes are located in a neck portion of the hopper and are located such that they are not easily accessible by a user. The lid of the hopper may include an interlock system which detects when the lid is secured, and the electric charges on the electrodes can be electrically generated only after it is detected that the lid has been secured. The coffee grinding machine with the electrodes in the hopper may also be used with other known dispensing systems.

### Various Forms of the Dispensing System 10 Described Above May Have One or More of the following advantages.

The dispensing system 10 discharges the electrostatic charges formed on the ground coffee particles during the grinding process which minimizes or eliminates scattering of the ground coffee particles as they are being dispensed. Moreover, the output voltage being applied to the first and second electrodes 110, 120 can be adjusted, which allows the dispensing system 10 to be customized to suit a particular type of coffee beans and to vary the amount of scattering. Minimizing or eliminating scattering also ensures in an accurate amount of ground coffee being dispensed and the coffee brewed from the dispensed coffee grounds would have the desired flavour profile.

Although specific embodiments of the invention are illustrated and described herein, it will be appreciated by those of ordinary skill in the art that a variety of alternative and/or equivalent implementations exist. It should be appreciated that the exemplary embodiment or exemplary embodiments are examples only and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that in this document the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms “a” and “an” used herein are intended to be understood as meaning one or more unless explicitly stated otherwise. Moreover, the terms “first”, “second”, etc. are used merely as labels, and are not intended to impose numerical requirements on or to establish a certain ranking of importance of their objects.

1. A dispensing system configured to dispense ground coffee and located adjacent a coffee grinder, the dispensing system comprising:
an outlet connected to a chamber containing the ground coffee, the outlet having an opening through which the ground coffee is dispensed;
at least one electrode located in the outlet; and
a booster circuit configured to generate an output voltage higher than an input voltage,
the booster circuit being connected to the at least one electrode,
wherein the output voltage is used to generate an electric charge on the at least one electrode, and
wherein the output voltage is adjustable by a user.

2. The dispensing system of claim 1, wherein the at least one electrode comprises a first electrode and a second electrode, the first and second electrodes being located across a flow pathway of the ground coffee through the outlet.

3. The dispensing system of claim 1, wherein the second electrode is spaced from and located across the first electrode.

4. (canceled)

5. The dispensing system of claim 1, wherein the electric charge generated on the at least one electrode is adjustable.

6. The dispensing system of claim 1, wherein the at least one electrode is located at an end of the outlet that is adjacent the chamber.

7. The dispensing system of-any claim 1, wherein the output voltage is in the range of about ±1000-1500 V.

8. The dispensing system of claim 1, wherein the chamber has a grinding member to grind coffee beans.

9. The dispensing system of claim 1, wherein the ground coffee comprises a plurality of electrically charged particles.

10. The dispensing system of claim 9, wherein electrostatic charges on the electrically charged particles are discharged by the at least one electrode.

11. A method of dispensing ground coffee from an opening located adjacent a coffee grinder, the method comprising:
causing the ground coffee contained in a chamber to flow through an outlet, the opening being located at a distal end of the outlet;
generating, by a booster circuit, an output voltage higher than an input voltage, the booster circuit being connected to at least one electrode located in the outlet;
generating, with the output voltage, an electric charge on the at least one electrode; and
dispensing the ground coffee from the opening subsequent to the ground coffee having flowed past the at least one electrode, wherein the output voltage is adjustable by a user.

12. (canceled)

13. The method of claim 11, or wherein generating the electric charge on the at least one electrode includes adjusting the electric charge generated on the at least one electrode.

14. The method of claim 11, wherein the at least one electrode comprises a first electrode and a second electrode spaced from the first electrode, and
wherein the ground coffee flows through the space between the first and second electrodes.

15. The method of claim 11, wherein the ground coffee comprises a plurality of electrically charged particles, and
wherein the electrostatic charges on the electrically charged particles are discharged by the at least one electrode as the ground coffee flows past the at least one electrode.
